(19) United States
(12) Patent Application Publication
(10) Pub. No.: US 2022/0178191 A1
(43) Pub. Date: Jun. 9, 2022

(54) Dump Truck Tailgate Lifting Assist Devices

(71) Applicant: R.G. Charles Hammond, Kingston, MA (US)

(72) Inventor: R.G. Charles Hammond, Kingston, MA (US)

(21) Appl. No.: 17/542,366

(22) Filed: Dec. 4, 2021

Related U.S. Application Data
(60) Provisional application No. 63/122,884, filed on Dec. 8, 2020.

(51) Int. Cl. E05F 11/02; B60P 1/12; F16D 41/12; E05F 5/00

(52) U.S. Cl. CPC E05F 11/02; B60P 1/12; E05Y 2900/546; E05F 5/00; E05Y 2201/218; F16D 41/12

(57) ABSTRACT

A tailgate lifting apparatus is provided that includes: a first cog, a second cog, and a housing fixedly attached to a dump body. Preferably, the first cog is fixedly attached to a lower hinge pin of the tailgate, the second cog is rotatably coupled to the housing, and the second cog meshes with the first cog. The housing includes a ratcheting mechanism that selectively engages the second cog, the device therewith operable therewith to maintain the tailgate in a plurality of positions between a fully opened and fully closed positions.

The present application claims priority to U.S. Prov. Patent Application No. 63/122,884 filed Dec. 8, 2020, which is incorporated herein by reference.

### BACKGROUND

The present application relates generally to tailgate lifting assist devices and more particularly devices for assisting users in lifting tailgates for dump trucks.

Unlike a pickup truck, the tailgate of a dump truck is a heavy, thick gauged, reinforced steel structure. Dump trick tailgates consist of two sets of transverse, horizontal hinges; one at the bottom of the tailgate and the other at the top. This arrangement gives the tailgate a top down capability and enables the tailgate to be lowered to any angle from fully closed to a position 180 degrees down. Raising and lowering the tailgate in this way is a manual operation and requires an effort of 70 lbs. to 110 lbs., depending upon the structure. In addition to the top down capability, when dumping a load, the driver pulls a lever from the front to release the tail-hook which allows the tail-gate to swing open freely on its top hinges as the body is raised to dump; making it possible to open in two opposing axial planes.

Accordingly, there is a need for an apparatus to assist with the raising and/or lift the tailgate of a dump truck.

### SUMMARY

A tailgate lifting assist device is provided that is preferably made from steel plates and includes two geared cogs that can mechanically reduce the physical effort required to raise and lower the tailgate, top down. Preferably, the device includes two, 1″ wide/thick solid enmeshing cogs, one above the other as shown in the accompanying figures. The driven cog (shown as the 18 tooth smaller cog in FIG. 1) is fitted (fixed) to the tailgate lower hinge-pin (1″ diameter).

A ⅜″ thick mounting plate/housing with the lower 36-tooth activating or driving cog is preferably welded to the base of the rear corner post of the dump-body allowing the two cogs to engage, one above the other, as shown in the figures. Using a ratcheting rod, for example, 24 inches long, to fit the 15/16 inch hexagonal extension of the axle of the lower 36-tooth cog, the operator can lower or raise the tail-gate on its lower hinges, as shown. In other embodiments, other tooth combinations may be used, such as 36/18, or any other that functionally provide a 2:1 ratio or greater gearing.

In one aspect, a tailgate lifting apparatus is provided that includes: a first cog, wherein the first cog is fixedly attached to a lower hinge pin of the tailgate; a second cog, wherein the second cog meshes with the first cog; and a housing fixedly attached to a dump body, wherein the second cog is rotatably coupled to the housing, wherein the housing comprises a ratcheting mechanism that selectively engages the second cog, the device therewith operable to maintain the tailgate in a plurality of positions between a fully opened and fully closed positions.

In one embodiment, the second cog has a diameter larger than a diameter of the first cog.

In one embodiment, wherein a ratio of a second cog diameter to a first cog diameter is at least 2:1.

In one embodiment, the housing includes a box section and wherein the second cog is located within and supported at a front and rear of the cog by the box section.

In one embodiment, the tailgate lifting apparatus includes a shaft passing through the box section and to which the second cog is attached.

In one embodiment, the shaft is set to be essentially parallel to the axis of the tailgate lower hinge pin.

In one embodiment, the shaft has a head shaped head to receive a driver.

In one embodiment, the shaft has a head shaped head to receive a hex driver and wherein the hex driver comprises a rod for manually rotating the shaft.

In one embodiment, the hex driver is one of a ratchet wrench or a breaker bar.

In one embodiment, the tailgate lifting apparatus includes a pawl functionally attached to the housing, wherein the pawl selectively engages teeth on the second cog to prevent the second cog from rotating in an opposite direction from a direction for lifting the liftgate.

In one embodiment, the tailgate lifting apparatus includes a ratcheting rod coupled to the pawl, the ratcheting rod operable to disengage the pawl from the second cog.

In one embodiment, the tailgate lifting apparatus includes a hook that when latched to the ratcheting rod, maintains the pawl in a freewheel position.

In one embodiment, the second cog is between about 2″ and about 6″.

In one embodiment, the first cog is between about 1″ and about 3″.

In one embodiment, the housing has a thickness of about ⅜″

In another aspect, a tailgate lifting apparatus is provided that includes: a first cog, wherein the first cog is fixedly attached to a lower hinge pin of the tailgate; a second cog, wherein the second cog meshes with the first cog; a housing fixedly attached to a dump body, wherein the second cog is rotatably coupled to the housing, wherein the housing comprises a ratcheting mechanism that selectively engages the second cog, the device therewith operable to maintain the tailgate in a plurality of positions between a fully opened and fully closed positions, wherein the second cog has a diameter larger than a diameter of the first cog, wherein the housing includes a box section and wherein the second cog is located within and supported at a front and rear of the cog by the box section and a shaft passing through the box section, the shaft essentially parallel to the axis of the tailgate lower hinge pin; a pawl functionally attached to the housing, wherein the pawl selectively engages teeth on the second cog to prevent the second cog from rotating in an opposite direction from a direction for lifting the liftgate; and a ratcheting rod coupled to the pawl, the ratcheting rod operable to disengage the pawl from the second cog.

Other aspects will be apparent to one skilled in the art in view of the present disclosure.

### BRIEF DESCRIPTION OF THE FIGURES

FIG. 1 is a partially disassembled side view of at least one embodiment of a tailgate lifting apparatus installed at the rear of a dump truck.

FIG. 2A is a top view of at least one embodiment of a tailgate lifting apparatus.

FIG. 2B is a side view of at least one embodiment of a tailgate lifting apparatus.

FIG. 3 is a front view of at least one embodiment of a tailgate lifting apparatus.

### DETAILED DESCRIPTION

The tailgate lifting assist apparatus or device, disclosed herein, provides for top down opening of the tailgate of a truck. The apparatus may be an all steel, cogged device to manually lower (open) and raise (close) the tailgate, as discussed further below. The mechanism generally includes three primary parts: a first gear (cog) 100 which is preferably welded or otherwise fixedly attached to the lower hinge pin 105 of the tailgate as shown in the accompanying figures. A second cog 102, preferably larger than the first cog 100, and mounting/housing 104 that is preferably welded or otherwise fixedly attached to the base of the rear corner post of the dump body 103 as also shown. The second cog 102 is rotatably located within the housing 104 such that the second cog 102 meshes with and is operable to rotate the first cog 100 and thus to rotate the tailgate 101 to which the first cog 100 is attached between open and closed orientations.

The second cog 102 may be rotatably attached to the housing in a variety of ways. In one embodiment, the second cog 102 is attached to a shaft 107 which is rotatably attached to the housing 104 and the shaft is set to be essentially parallel to the axis of the tailgate lower hinge pin 105. The outer end of the shaft 107 may have a hex shape to receive a hex driver. The hex driver may be a hex ratchet or breaker bar. The third primary part is a ratcheting rod 106 which engages the teeth of the second cog 102 to prevent the second cog 102 from rotating opposite from the desired direction for lifting the liftgate 101. The ratcheting rod 106 preferably includes a pawl hinged at an intersection of the pawl and the end of the rod 106 and configured therewith to engage teeth on the second cog 102 individually as the second cog 102 is being rotated in a direction that lifts the tailgate. The pawl further acts as a locking mechanism that secures the position of the tailgate so that it does not drop during ratcheting maneuvers. The device may further include a mechanism that disengages the pawl from the second cog 102. Preferably, this mechanism includes a hook 108 to which the ratcheting rod 106 latches onto and maintains the pawl in a freewheel position.

Each cog is preferably made of solid high-grade steel that is 1″ thick and the mounting (housing) is preferably also made from high grade steel plate that is ⅜″ thick, bent to accommodate the 2″-6″, or preferably 4″ activating/second cog 102. The ratio of the diameter of the second cog to the first cog is at least 2:1. The first cog 100 may therefore be 1″-3″, or preferably 2″ or greater. The ratchet or breaker bar needed to operate the device is preferably 24″ long. A built-in pawl in the housing determines the direction in which the 4″ driving/second cog needs to be rotated, as shown in the figures.

The gearing arrangement of the device preferably reduces the physical effort required to raise and lower a necessarily heavily constructed gate by at least 50%, say 50 lbs. versus 100 lbs. In addition to the apparent weight reduction, it is ergonomically easier to pull down with one hand to raise a weight than push upwards to raise that weight. The reverse is true for lowering the same weight. The device also allows the tailgate to still swing open freely on its upper hinge-pins without any interference or change to the two, independent axial planes of function of the tailgate. The device is sufficiently rugged to remain attached to the truck body at all times with minimal change in the dimensions of the body.

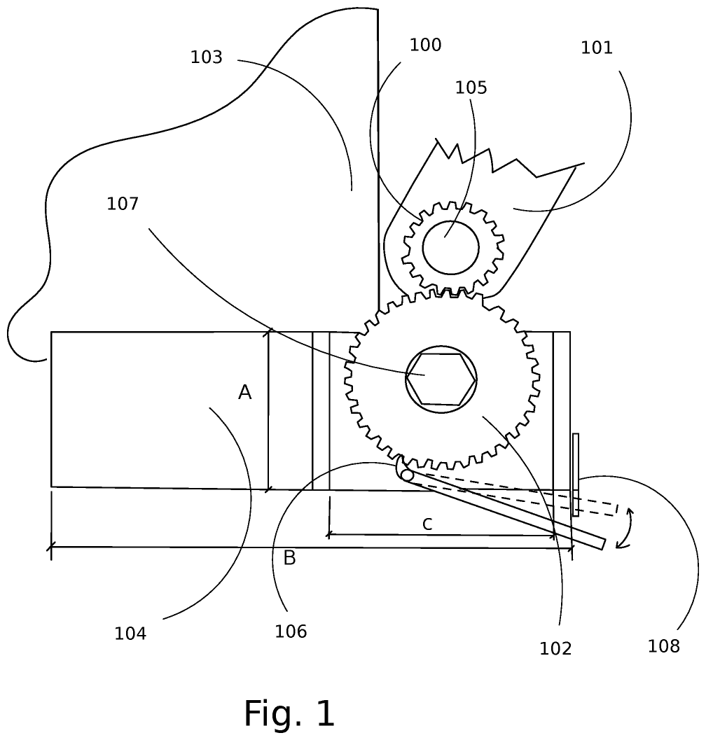

Referring to FIG. 1, the first cog 100 is preferably attached to the tailgate essentially sharing the same axis as the tailgate hinge. The second cog 102 is attached to housing 104 so as to engage the first cog 100 and be configured to rotate in the housing 104 and upon rotation cause opposite rotation in the first cog 100. The rotational movement is made possible using ratcheting wrench or breaker bar to rotate the second cog 102. To prevent unwanted movement (downward) while ratcheting, a pawl 106 may engage the second cog 102. FIG. 1 shows the device in a first position with the tailgate lowered slightly. Multiple positions may be held between the fully opened and fully closed positions depending on the number of teeth on the gearset.

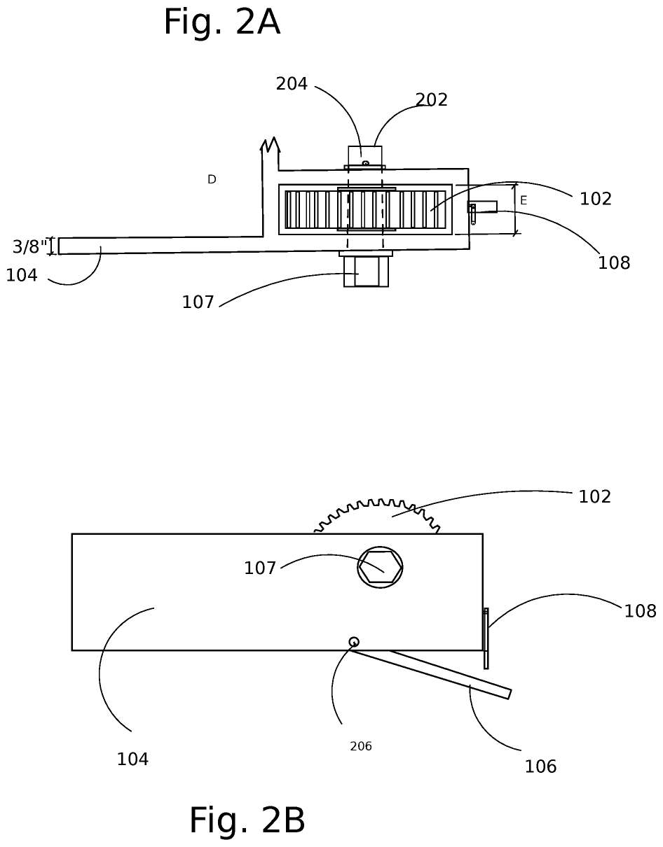

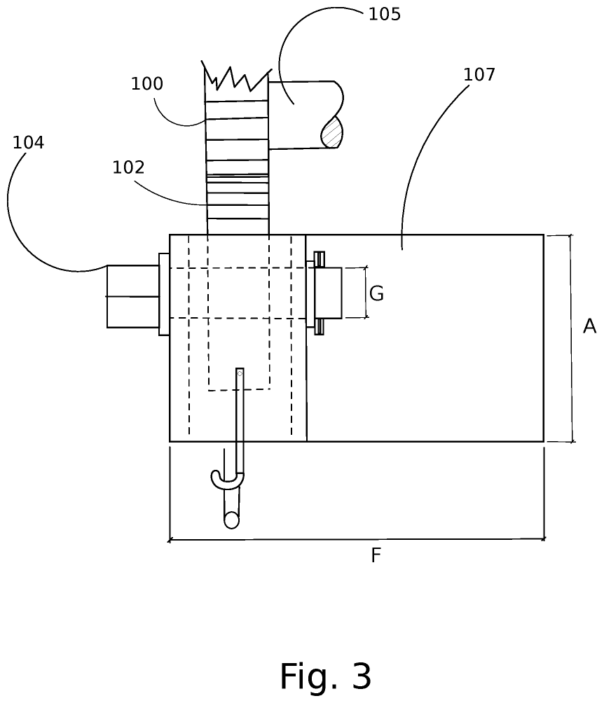

Referring to FIGS. 2A-2B and 3, in one embodiment, the housing 104 includes a box section that houses the second cog 102. The box section includes coaxial holes therein to receive the shaft 202 to which the second cog 102 is attached. The shaft 204 is rotatable about the axis thereof relative to the housing 104. The shaft 204 may be keyed to the second cog 102. At the proximal end of the shaft a hex shaped head 107 may be provided as discussed above. At the distal end, the shaft may be retained with a pin 204 as shown. The rod 106 may similarly be rotatably attached to the housing 104 via a second shaft 206, as shown.

The dimensions of the device may vary. Table A below provides dimensions for an exemplary embodiment.

| | Preferred | Preferred |
|---|---|---|
| Element | Range | Dimension |
| A | 2.75″-4.75″ | 3.25″ |
| B | 8.75″-10.75″ | 9.75″ |
| C | 4″-5″ | 4.125″ |
| D | 4″-6″ | 5.5″ |
| E | 1″-1.75″ | 1.375″ |
| F | 4″-6″ | 5.875″ |
| G | 0.5″-1.25″ | 0.75″ |

The present invention is described in the following Examples, which are set forth to aid in the understanding of the invention, and should not be construed to limit in any way the scope of the invention as defined in the claims which follow thereafter.

1. A tailgate lifting apparatus comprising:
a first cog, wherein the first cog is fixedly attached to a lower hinge pin of the tailgate;
a second cog, wherein the second cog meshes with the first cog; and
a housing fixedly attached to a dump body, wherein the second cog is rotatably coupled to the housing, wherein the housing comprises a ratcheting mechanism that selectively engages the second cog, the device therewith operable to maintain the tailgate in a plurality of positions between a fully opened and fully closed positions.

2. The tailgate lifting apparatus of claim 1, wherein the second cog has a diameter larger than a diameter of the first cog.

3. The tailgate lifting apparatus of claim 1, wherein a ratio of a second cog diameter to a first cog diameter is at least 2:1.

4. The tailgate lifting apparatus of claim 1, wherein the housing includes a box section and wherein the second cog is located within and supported at a front and rear of the cog by the box section.

5. The tailgate lifting apparatus of claim 4, comprising a shaft passing through the box section and to which the second cog is attached.

6. The tailgate lifting apparatus of claim 5, wherein the shaft is set to be essentially parallel to the axis of the tailgate lower hinge pin.

7. The tailgate lifting apparatus of claim 5, wherein the shaft has a head shaped head to receive a driver.

8. The tailgate lifting apparatus of claim 5, wherein the shaft has a head shaped head to receive a hex driver and wherein the hex driver comprises a rod for manually rotating the shaft.

9. The tailgate lifting mechanism of claim 8, wherein the hex driver is one of a ratchet wrench or a breaker bar.

10. The tailgate lifting apparatus of claim 1, comprising a pawl functionally attached to the housing, wherein the pawl selectively engages teeth on the second cog to prevent the second cog from rotating in an opposite direction from a direction for lifting the liftgate.

11. The tailgate lifting apparatus of claim 10, comprising a ratcheting rod coupled to the pawl, the ratcheting rod operable to disengage the pawl from the second cog.

12. The tailgate lifting apparatus of claim 11, comprising a hook that when latched to the ratcheting rod, maintains the pawl in a freewheel position.

13. The tailgate lifting apparatus of claim 1, wherein the second cog is between about 2″ and about 6″.

14. The tailgate lifting apparatus of claim 13, wherein the first cog is between about 1″ and about 3″.

15. The tailgate lifting apparatus of claim 1, wherein the housing has a thickness of about ⅜″.

16. A tailgate lifting apparatus comprising:
a first cog, wherein the first cog is fixedly attached to a lower hinge pin of the tailgate;
a second cog, wherein the second cog meshes with the first cog;
a housing fixedly attached to a dump body, wherein the second cog is rotatably coupled to the housing, wherein the housing comprises a ratcheting mechanism that selectively engages the second cog, the device therewith operable to maintain the tailgate in a plurality of positions between a fully opened and fully closed positions,
wherein the second cog has a diameter larger than a diameter of the first cog,
wherein the housing includes a box section and wherein the second cog is located within and supported at a front and rear of the cog by the box section and a shaft passing through the box section, the shaft essentially parallel to the axis of the tailgate lower hinge pin;
a pawl functionally attached to the housing, wherein the pawl selectively engages teeth on the second cog to prevent the second cog from rotating in an opposite direction from a direction for lifting the liftgate; and
a ratcheting rod coupled to the pawl, the ratcheting rod operable to disengage the pawl from the second cog.

17. The tailgate lifting apparatus of claim 16, wherein a ration of a second cog diameter to a first cog diameter is at least 2:1.

18. The tailgate lifting apparatus of claim 5, wherein the shaft has a head shaped head to receive a driver.

19. The tailgate lifting apparatus of claim 5, wherein the shaft has a head shaped head to receive a hex driver and wherein the hex driver comprises a rod for manually rotating the shaft.

20. The tailgate lifting apparatus of claim 11, comprising a hook that when latched to the ratcheting rod, maintains the pawl in a freewheel position.
